(19) United States
(12) Patent Application Publication
(10) Pub. No.: US 2026/0210535 A1
(43) Pub. Date: Jul. 23, 2026

(54) LIGHTING APPARATUS

(71) Applicant: LEEDARSON LIGHTING CO.,LTD., Zhangzhou (CN)

(72) Inventors: Webin ZHEN, Zhangzhou (CN); Qinpeng LI, Zhangzhou (CN); Guanwei LI, Zhangzhou (CN); Erfeng FANG, Zhangzhou (CN)

(21) Appl. No.: 19/455,850

(22) Filed: Jan. 22, 2026

(30) Foreign Application Priority Data
Jan. 22, 2025 (CN) 202520152172.4

(51) Int. Cl. F21V 23/00; F21V 5/04; F21V 29/70; F21Y 113/00; F21Y 115/10

(52) U.S. Cl. CPC F21V 23/003; F21V 5/04; F21V 29/70; F21Y 2113/00; F21Y 2115/10

(57) ABSTRACT

A lighting apparatus includes a housing that encloses internal components and defines an output direction for illumination. A first light source is arranged within the housing and emits a first light beam having a first spread angle. A second light source is positioned within the housing at least partially around a peripheral region of the first light source and emits a second light beam having a second spread angle. A driver module is electrically coupled to the first and second light sources to control output intensities of the respective light beams. The first and second light beams are projected in the output direction to form a combined illumination pattern. The first spread angle and the second spread angle partially overlap, thereby improving illumination coverage and uniformity.

### FIELD

The present invention is related to a lighting apparatus, and more particularly related to a lighting apparatus with flexible light pattern.

### BACKGROUND

Lighting devices are widely used in outdoor and architectural environments to provide visibility, safety, and aesthetic appeal. In many applications, such as gardens, pathways, and landscape features, lighting is expected not only to illuminate an area but also to create a pleasingvisual atmosphere. As a result, designers often seek lighting arrangements that can deliver both focused illumination and broader ambient light within a single fixture.

Conventional lighting products are often designed with a fixed beam pattern, which may limit their usefulness across different settings. A narrow beam may highlight specific objects but leave surrounding areas underlit, while a wide beam may provide general illumination but lack emphasis or depth. Users therefore may need to install multiple lighting fixtures or select different products to achieve the desired visual effect.

Advances in solid-state lighting, particularly light emitting diode technology, have expanded the range of lighting configurations available to designers. LEDs allow for compact form factors, energy-efficient operation, and flexible control of light output. These characteristics have encouraged the integration of multiple light sources within a single housing to produce more complex illumination patterns.

Optical elements such as lenses and reflectors are commonly employed to shape and direct light emitted from a source. By selecting different optical structures, a lighting device can produce beams with varying spread angles, intensity distributions, and visual characteristics. The interaction between multiple optical elements within a single lighting device can influence the overall appearance and uniformity of the emitted light.

In outdoor environments, lighting conditions and user preferences may vary over time. For example, a garden area may require accent lighting at certain times and broader illumination at others. Environmental factors such as plant growth, seasonal changes, and surrounding structures can also affect how light is perceived. These variations create a desire for lighting systems that can adapt to changing conditions without requiring physical replacement or extensive modification.

Control electronics have become increasingly important in modern lighting systems. Driver circuits can regulate brightness, color characteristics, and operational modes, allowing lighting devices to respond to user input or environmental signals. The inclusion of programmable control features enables lighting products to offer multiple lighting scenes or behaviors within a single unit.

Energy efficiency and power management are also significant considerations, especially for outdoor and garden lighting. Many installations rely on limited power sources such as batteries or solar energy. Efficient use of available energy can extend operating time and reduce maintenance requirements, which is particularly valuable for lighting devices installed in remote or hard-to-access locations.

User interaction with lighting devices has evolved beyond simple on-off switches. Touch sensors, wireless controls, and automated timers are increasingly common, providing users with more intuitive and flexible ways to manage lighting behavior. These interfaces can enhance convenience while allowing the lighting system to operate autonomously when desired.

Thermal management remains an important aspect of lighting design, particularly as multiple light sources and electronic components are integrated into compact housings. Effective dissipation of heat can contribute to stable operation, consistent light output, and extended component lifespan. Housing structures are therefore often designed to balance aesthetic, mechanical, and thermal considerations.

Overall, the development of lighting apparatuses continues to reflect a balance between visual performance, adaptability, energy efficiency, and user experience. As lighting applications become more diverse, there is ongoing interest in designs that can provide multiple illumination characteristics within a single, integrated system while remaining suitable for a wide range of environments and installation scenarios.

### SUMMARY

In some embodiments, a lighting apparatus includes a housing, a first light source, a second light source and a driver module.

The housing is configured to enclose internal components.

The housing defines an output direction for illumination.

The first light source is disposed within the housing.

The first light source is configured to emit a first light beam having a first spread angle.

The second light source is disposed within the housing at a position located at least partially along a peripheral side of the first light source.

The second light source is configured to emit a second light beam having a second spread angle.

The driver module is electrically coupled to the first light source and the second light source to regulate an output intensity of the first light beam and the second light beam.

The first light beam and the second light beam are projected to form a combined illumination pattern.

The first spread angle and the second spread angle at least partially overlap.

In some embodiments, the lighting apparatus may also include a first optical element and a second optical element.

The first optical element is disposed adjacent to the first light source and includes a total internal reflection (TIR) lens structure to collimate the first light beam.

The second optical element is disposed adjacent to the second light source and operates in conjunction with a reflector cup to direct the second light beam.

In some embodiments, the first spread angle is configured to be in a range of 24 degrees to 40 degrees to provide a spotlight effect. In some embodiments, the first spread angle is between 20 degrees to 110 degrees, and the second spreading angle is between 20 degrees to 110 degrees.

The second spread angle is configured to be in a range of 60 degrees to 110 degrees to provide a floodlight effect.

The second spread angle is wider than the first spread angle to form the combined illumination pattern with a central bright zone and a peripheral gradient zone.

In some embodiments, the first optical element or the second optical element includes an exit surface having a micro-lens array.

The micro-lens array is arranged in a Fermat spiral distribution or a non-aspherical coordinate distribution defined by a specific curvature formula to enhance light mixing uniformity.

In some embodiments, the reflector cup surrounds the first light source and separates the first light source from the second light source.

The reflector cup includes a faceted or scaled reflective surface configured to reflect stray light from the first light source or the second light source back into the first optical element or the second optical element.

In some embodiments, the first light source and the second light source each comprise at least one light emitting diode (LED) module.

The LED module is configured to emit light of a selectable color temperature or a selectable RGB color.

The driver module is configured to independently adjust a color output of the first light source and the second light source.

In some embodiments, the first light source or the second light source includes a plurality of independently addressable LED sets.

The driver module is configured to selectively activate a subset of the plurality of independently addressable LED sets to discretely modify the first spread angle or the second spread angle without moving mechanical parts.

In some embodiments, the driver module is configured to adjust a color temperature of the combined illumination pattern by mixing a first color temperature output from the first light source and a second color temperature output from the second light source.

In some embodiments, the lighting apparatus may also include a third light source.

The third light source is disposed physically between the first light source and the second light source.

The third light source is configured to emit a third light beam to bridge a transition gap between the first light beam and the second light beam to create a continuous light pattern.

In some embodiments, the lighting apparatus may also include a movable mechanism.

The movable mechanism is coupled to the first light source or the second light source to enable a relative displacement between the light sources and the housing.

The relative displacement modifies the first spread angle or the second spread angle to adapt to different garden environments.

In some embodiments, the driver module is configured to adjust an output ratio between the first light source and the second light source.

The driver module operates in a first mode where the first light source dominates for a spotlight effect, and a second mode where the second light source dominates for a wide- area illumination effect.

In some embodiments, the driver module is configured to apply a compensation formula.

When the driver module increases an intensity of the first light source, the driver module automatically decreases an intensity of the second light source according to the compensation formula to maintain a total power output orto achieve a specific beam transition effect.

In some embodiments, the driver module includes a memory unit storing a look-up table.

The look-up table defines a non-linear mapping relationship between a user control input and corresponding output intensities of the first light source and the second light source.

In some embodiments, the lighting apparatus may also include a manual switch or a touch sensor.

The manual switch or the touch sensor is disposed on the housing.

An actuation of the manual switch or the touch sensor triggers the driver module to cycle through a set of pre-defined spread angle configurations.

In some embodiments, the lighting apparatus may also include a power management unit, a rechargeable battery, and a solar panel interface.

The solar panel interface is adapted to connect to a photovoltaic module to charge the rechargeable battery.

The power management unit powers the driver module.

In some embodiments, the driver module is configured to monitor a capacity level of the rechargeable battery.

The driver module automatically restricts a maximum intensity of the first light source or the second light source when the capacity level falls below a predetermined threshold.

In some embodiments, the driver module further includes a timer circuit.

The timer circuit is configured to deactivate the lighting apparatus or dim the first light source and the second light source after a predetermined duration or at a specific time of day to conserve energy.

In some embodiments, the lighting apparatus may also include a wireless communication module.

The wireless communication module is configured to receive a wireless broadcast signal.

The driver module activates a specific lighting scene or synchronization mode upon receipt of the wireless broadcast signal.

In some embodiments, the lighting apparatus may also include a mounting stake.

The mounting stake is coupled to the housing.

The mounting stake is configured to anchor the lighting apparatus into a ground surface for garden or pathway illumination.

In some embodiments, the housing includes a heat sink structure constructed from a thermally conductive material.

The heat sink structure is thermally coupled to the first light source and the second light source to dissipate heat generated during operation to an external environment.

### BRIEF DESCRIPTION OF DRAWINGS

FIG. 1 is a schematic structural diagram of a mixed-light luminaire according to one embodiment, illustrating a general arrangement of light sources, optical elements, control module, and housing.

FIG. 2a is a schematic diagram illustrating a first beam angle generated by a first light source of the mixed-light luminaire according to one embodiment.

FIG. 2b is a schematic diagram illustrating a second beam angle generated by a second light source of the mixed-light luminaire according to one embodiment.

FIG. 2c is a schematic diagram illustrating an overlap relationship between the first beam angle and the second beam angle of the mixed-light luminaire according to one embodiment.

FIG. 3a is a schematic diagram illustrating a first beam angle of a mixed-light luminaire in which a second light source is disposed laterally relative to a first light source according to one embodiment.

FIG. 3b is a schematic diagram illustrating a second beam angle of the mixed-light luminaire shown in FIG. 3a according to one embodiment.

FIG. 3c is a schematic diagram illustrating an overlapping beam pattern formed by the first beam angle and the second beam angle of the mixed-light luminaire shown in FIG. 3a according to one embodiment.

FIG. 4 is a schematic structural diagram of a lighting apparatus showing internal components including a housing, light sources, driver module, wireless module, power management unit, battery, and heat sink according to one embodiment.

FIG. 5 is a schematic optical structural diagram illustrating a first optical element, a second optical element, a reflector cup, and related beam angle definitions according to one embodiment.

FIG. 6 is a schematic diagram illustrating a lighting apparatus with a movable mechanism configured to adjust a relative position between light sources and a housing according to one embodiment.

FIG. 7 is an optical component example showing a lens structure example.

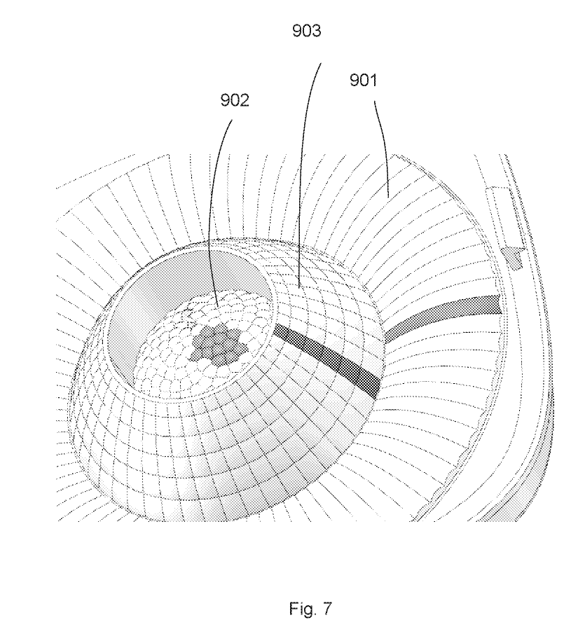

FIG. 8 shows another lighting apparatus embodiment.

### DETAILED DESCRIPTION

Reference will now be made in detail to illustrative embodiments of the invention, examples of which are shown in the accompanying drawings. The same reference numerals are used throughout the drawings to refer to the same or like elements. The following description is provided to explain the structure, operation, and implementation of the lighting apparatus, and to enable a person having ordinary skill in the art to make and use the invention.

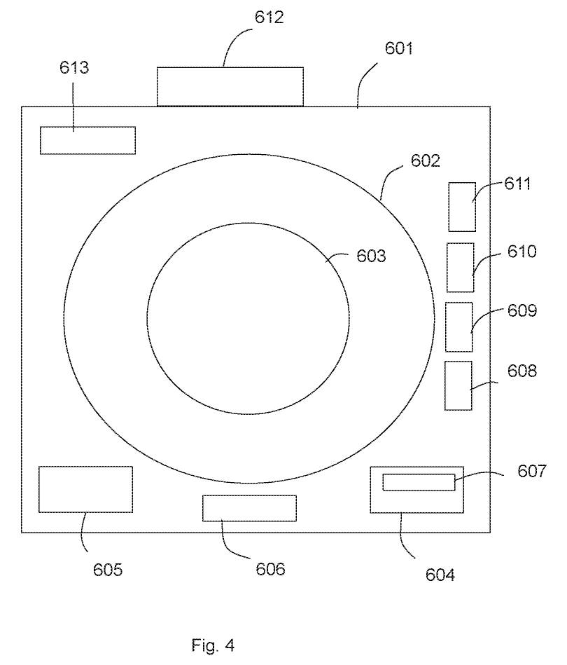

As shown in FIG. 4, the lighting apparatus includes a housing 601. The housing 601 is configured to enclose and support internal components of the lighting apparatus, including light sources, optical elements, and electronic control circuitry. The housing 601 defines an output direction for illumination, which may be oriented generally forward, downward, or at an inclined angle depending on installation requirements. In outdoor implementations, such as garden or pathway lighting, the housing 601 may be formed of a thermally conductive metal, molded plastic, or a composite material, and may further include sealing features to provide resistance to moisture, dust, and environmental exposure.

A first light source 603 is disposed within the housing 601, as illustrated in FIG. 4. The first light source 603 is configured to emit a first light beam having a first spread angle. In one embodiment, the first light source 603 is arranged along a primary optical axis of the housing 601 to generate a concentrated illumination region. The first light source 603 may include one or more light emitting diodes (LEDs), chip-on-board LED packages, or other solid-state light emitters. The first spread angle may be selected to provide a focused or spotlight-type illumination suitable for highlighting specific objects such as plants, sculptures, or architectural features.

A second light source 602 is also disposed within the housing 601, as further shown in FIG. 4. The second light source 602 is positioned at least partially along a peripheral side of the first light source 603. In this configuration, the second light source 602 surrounds or partially surrounds the first light source 603 when viewed along the output direction. The second light source 602 is configured to emit a second light beam having a second spread angle that is different from the first spread angle. In particular, the second spread angle is broader than the first spread angle, such that the second light source 602 produces a wider-area illumination pattern around the central beam generated by the first light source 603.

A driver module 604 is electrically coupled to the first light source 603 and the second light source 602. The driver module 604 regulates the output intensity of the first light beam and the second light beam by controlling current, voltage, duty cycle, or other electrical drive parameters supplied to the light sources. As a result, the first light beam and the second light beam are projected simultaneously to form a combined illumination pattern. The combined illumination pattern may include a central high-intensity region corresponding to the first light beam and a surrounding lower-intensity or gradient region corresponding to the second light beam. The first spread angle and the second spread angle at least partially overlap, which helps to reduce sharp boundaries between illuminated regions and improves visual uniformity.

After the basic structural elements of the lighting apparatus have been described, further explanations, examples, and variations are provided below to illustrate optional implementations and design flexibility.

With respect to the housing 601, the housing may be integrally formed as a single body or assembled from multiple parts. In some embodiments, the housing 601 may include internal mounting bosses or brackets to precisely locate the first light source 603 and the second light source 602 relative to one another. The housing 601 may also incorporate optical apertures, transparent covers, or protective lenses aligned with the output direction. Variations of the housing shape may include cylindrical, rectangular, polygonal, or custom aesthetic forms, depending on design preference.

Regarding the first light source 603, the first light source may be configured to emit white light, monochromatic light, or multi-color light. In some examples, the first light source 603 may be optimized for higher luminous intensity or higher center-beam candlepower to emphasize a spotlight effect. The first spread angle may be fixed by optical design or may be adjustable through optical or electronic means.

Regarding the second light source 602, the second light source may include a plurality of LEDs arranged in a ring, arc, or segmented pattern around the first light source 603. The second light source 602 may be optimized for lower intensity per unit area but a wider angular distribution, thereby producing a floodlight effect. In alternative implementations, the second light source 602 may be divided into independently controllable segments to allow asymmetric or directional peripheral illumination.

With respect to the driver module 604, the driver module may include analog or digital control circuitry, a microcontroller, or application-specific integrated circuits (ASICs). The driver module 604 may support multiple operating modes, such as a mode emphasizing the first light source 603, a mode emphasizing the second light source 602, or a blended mode in which both light sources contribute to the combined illumination pattern. The driver module 604 may further include memory or programmable parameters to store user-defined or factory-defined lighting profiles.

In operation, the lighting apparatus may be used in various applications where both focused and wide-area illumination are desirable. For example, the first light source 603 may highlight a specific target, while the second light source 602 softly illuminates surrounding areas to improve safety and aesthetics. The overlapping spread angles help ensure a smooth transition between illumination regions without visible discontinuities.

In some embodiments, the mixing of light emitted from the first light source 603 and the second light source 602 is achieved through controlled spatial overlap of the first light beam and the second light beam. By configuring the first spread angle and the second spread angle to partially overlap along the output direction of the housing 601, light from the second light source 602 fills peripheral regions of the first light beam. This spatial overlap reduces abrupt intensity transitions and minimizes visible artifacts such as hot spots or dark rings. The degree of overlap may be selected based on beam simulation results, installation height, or intended viewing distance.

In further embodiments, light mixing is enhanced through optical path interaction within the housing 601. Reflections from internal surfaces of the housing 601, including reflective coatings or textured walls, may redirect portions of the first light beam toward regions primarily illuminated by the second light beam, and vice versa. Such indirect reflections promote secondary mixing before the light exits the housing 601. In one example, diffuse reflective surfaces are used to scatter a small percentage of light, thereby improving uniformitywithout significantly reducing overall optical efficiency.

In some implementations, the driver module 604 plays an active role in light mixing by dynamically adjusting the relative intensities of the first light source 603 and the second light source 602. By applying predetermined ratios or algorithms, the driver module 604 can modify the balance between the central beam and the peripheral beam in response to user input, ambient conditions, or operating modes. This electronic mixing approach allows the combined illumination pattern to be tuned without mechanical movement of optical components.

In certain embodiments, temporal mixingtechniques may be employed in addition to spatial mixing. The driver module 604 may alternately or pulse-width-modulate the first light source 603 and the second light source 602 at a frequency sufficiently high to be imperceptible to the human eye. Through persistence of vision, the alternating emissions are perceived as a single, blended illumination pattern. Temporal mixing may be used to fine-tune brightness distribution, color consistency, or thermal performance.

In other embodiments, color-based light mixing is implemented when the first light source 603 and the second light source 602 emit light of different color temperatures or spectral compositions. By adjusting the output intensities of the two light sources, the driver module 604 can produce a combined illumination pattern having a desired correlated color temperature or color rendering characteristic. This spectral mixing may be used to create warm-to-cool gradients, adaptive white lighting, or decorative lighting effects while maintaining a smooth spatial transition between the central and peripheral illumination regions.

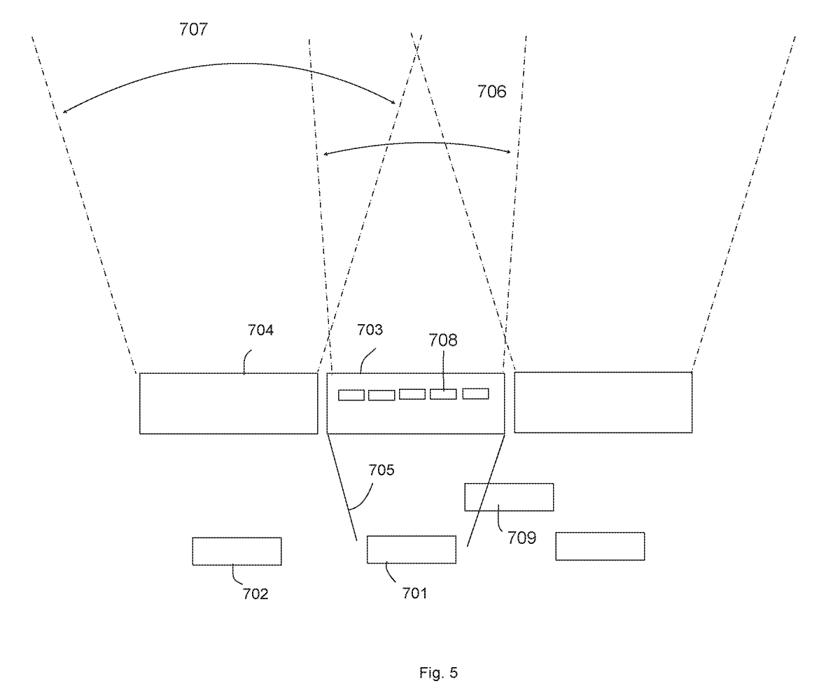

With reference to FIG. 5, the lighting apparatus further includes a first optical element 703 disposed adjacent to the first light source 701. The first optical element 703 is configured to receive light emitted from the first light source and to shape the angular distribution of the first light beam. In one embodiment, the first optical element 703 is positioned directly above or around the emitting surface of the first light source 701 to maximize light collection efficiency and to ensure optical alignment with the output direction defined by the housing 601.

In some embodiments, the first optical element 703 comprises a total internal reflection (TIR) lens structure. The TIR lens utilizes internal reflective surfaces to redirect light rays emitted at high angles back toward the forward output direction. This optical configuration enables efficient collimation of the first light beam without requiring metallic reflectors, thereby reducing optical losses and simplifying assembly. The TIR lens may include a central refractive region and a surrounding reflective region to manage both axial and off-axis light components.

The lighting apparatus further includes a second optical element 704 disposed adjacent to the second light source. The second optical element 704 cooperates with a reflector cup 705 to direct light emitted from the second light source toward the output direction. The second optical element 704 may be a transmissive lens, diffuser, or protective window, and may be designed to slightly diffuse or shape the light after reflection by the reflector cup 705.

In operation, the first optical element 703 primarily controls the angular distribution of the first light beam, while the second optical element 704 and the reflector cup 705 collectively control the angular distribution of the second light beam. This separation of optical functions allows the first light beam and the second light beam to be independently optimized for different illumination purposes, such as spotlighting and floodlighting, respectively.

Various modifications of the optical elements are possible. For example, the first optical element 703 may be replaced with a hybrid refractive-reflective lens, and the second optical element 704 may incorporate diffusive textures or prismatic features. These variations allow designers to tailor beam profiles, glare characteristics, and optical efficiency while maintaining the overall architecture described herein.

As illustrated in FIG. 5, the first spread angle 706 of the first light beam may be configured within a range of approximately 24 degrees to 40 degrees. This range is selected to provide a focused illumination pattern that concentrates light energy within a relatively narrow angular region. Such a configuration is suitable for applications requiring emphasis on a specific target area or object.

The second spread angle 707 of the second light beam may be configured within a range of approximately 60 degrees to 110 degrees. This wider angular distribution produces a floodlight effect that illuminates a larger surrounding area. The second spread angle 707 is intentionallywider than the first spread angle 706 to ensure that peripheral regions receive sufficient illumination.

When the first light beam and the second light beam are emitted simultaneously, the differing spread angles produce a combined illumination pattern having a central bright zone and a surrounding peripheral gradient zone. The central bright zone is primarily formed by the first light beam, while the peripheral gradient zone is primarily formed by the second light beam. Partial overlap between the two beams ensures a smooth transition between these regions.

The selection of the specific angular ranges may depend on installation height, distance to the illuminated surface, and desired visual effect. For example, narrower first spread angles may be used for tall fixtures, while wider second spread angles may be used for low-mounted garden lights.

In alternative embodiments, the spread angles may be dynamically adjusted through electronic control or interchangeable optical components. Such flexibility allows the same lighting apparatus to be adapted for different environments or use cases without structural modification.

In some embodiments, the first optical element 703 or the second optical element 704 includes an exit surface having a micro-lens array 708. The micro-lens array 708 consists of a plurality of small lens features formed on the exit surface to locally redirect light rays. These micro-lenses function to redistribute light energy at a fine scale, improving uniformity across the output beam.

The micro-lens array 708 may be arranged according to a Fermat spiral distribution. This distribution avoids repetitive angular patterns and reduces the likelihood of visible optical artifacts, such as rings or bands, in the projected illumination. The spiral arrangement promotes even angular coverage and enhances mixing between overlapping light beams.

In other embodiments, the micro-lens array 708 may be arranged according to a non-aspherical coordinate distribution defined by a specific curvature formula. Such a distribution allows precise control over ray deviation angles and can be optimized using optical simulation tools. This approach enables fine tuning of beam smoothness and edge roll-off characteristics.

By incorporating the micro-lens array 708, the lighting apparatus can achieve improved color and intensity uniformity, particularly in regions where the first light beam and the second light beam overlap. The micro-lens array helps to blend light from different sources and reduce sharp intensity gradients.

Variations of the micro-lens array may include different lens shapes, sizes, or surface textures. The micro-lens array may be integrally molded with the optical element or applied as a secondary optical film, depending on manufacturing considerations.

In further embodiments, the reflector cup 705 surrounds the first light source and separates the first light source from the second light source. The reflector cup 705 serves both an optical and a structural function by defining distinct optical paths for the two light sources while maintaining compact integration within the housing 601.

The reflector cup 705 may include a faceted or scaled reflective surface. These surface features are configured to reflect stray light emitted from the first light source or the second light source back toward the intended optical paths. Faceted surfaces may redirect light in controlled directions, while scaled or stepped surfaces may promote diffuse reflection.

By reflecting stray light back into the first optical element 703 or the second optical element 704, the reflector cup 705 improves overall optical efficiency. Light that would otherwise be absorbed or lost within the housing is recycled into the useful output beam.

The reflector cup 705 may be formed from a metal substrate with a reflective coating, such as aluminum or silver, or from a plastic substrate with a reflective surface treatment. The choice of material and surface finish may be based on reflectivity, durability, and cost considerations.

In alternative implementations, the reflector cup 705 may include hybrid reflective- diffusive regions to balance efficiency and uniformity. Such variations allow designers to customize beam shape, edge softness, and mixing characteristics while preserving the functional separation between the first and second light sources.

In further embodiments, the first light source 603 and the second light source 602 each comprise at least one light emitting diode (LED) module. Each LED module may include one or more LED dies mounted on a substrate and electrically connected to the driver module 604. The LED modules may be selected based on desired luminous efficacy, color rendering index, thermal performance, and operational lifetime. By using solid-state LED modules for both light sources, the lighting apparatus achieves high efficiency and reliability suitable for long-term outdoor operation.

In some implementations, the LED modules of the first light source 603 or the second light source 602 are configured to emit light of a selectable color temperature. For example, the LED modules may include warm white, neutral white, or cool white LEDs, or may include multi-channel LEDs capable of producing different correlated color temperatures through controlled mixing. This enables the lighting apparatus to adapt to different aesthetic preferences or environmental conditions.

In other embodiments, the LED modules may be configured to emit selectable RGB colors. Each LED module may include red, green, and blue LED dies that are independently controllable by the driver module 604. Through additive color mixing, the lighting apparatus can generate a wide range of colors for decorative, signaling, or thematic lighting applications. The RGB capability may be provided for one or both of the first light source 603 and the second light source 602.

The driver module 604 is configured to independently adjust a color output of the first light source 603 and the second light source 602. This independent control allows the central illumination region and the peripheral illumination region to have different color characteristics if desired. For example, the first light source 603 may emit a cooler white light for visual emphasis, while the second light source 602 emits a warmer white or colored light to create ambient effects.

Variations of this configuration may include LED modules with tunable spectra beyond RGB, such as RGBW or multi-channel phosphor-based LEDs. The driver module 604 may implement calibration routines to ensure color consistency over time and across temperature variations. These variations allow flexible color control while maintaining the overall lighting architecture.

In further embodiments, the first light source 603 or the second light source 602 comprises a plurality of independently addressable LED sets. Each LED set may include one or more LED modules that are electrically isolated from other sets and individually controlled by the driver module 604. This structure enables selective activation or deactivation of specific LED sets within a light source.

By selectively activating a subset of the plurality of independently addressable LED sets, the driver module 604 can discretely modify the first spread angle or the second spread angle. For example, activating only central LED sets may result in a narrower effective beam, while activating additional peripheral LED sets may widen the beam. This adjustment is achieved without moving mechanical parts, thereby improving durability and reducing mechanical complexity.

In some implementations, the independently addressable LED sets are arranged in concentric rings, linear arrays, or segmented zones. The spatial arrangement of these LED sets determines how the effective beam profile changes when different sets are activated. Optical elements associated with each set may further refine the resulting beam distribution.

The driver module 604 may store predefined activation patterns corresponding to different beam shapes or illumination modes. These patterns may be selected based on user input, installation scenarios, or automated control logic. For example, a narrow-beam mode may be used for accent lighting, while a wide-beam mode may be used for general area illumination.

Alternative implementations may include partial activation of LED sets using pulse- width modulation or current scaling to provide intermediate beam shapes. Such electronic beam shaping provides fine-grained control over illumination characteristics while maintaining a fixed optical structure.

In additional embodiments, the driver module 604 is configured to adjust a color temperature of the combined illumination pattern by mixing a first color temperature output from the first light source 603 and a second color temperature output from the second light source 602. By controlling the relative intensities of the two light sources, the driver module 604 can generate an overall color temperature that lies between the individual color temperatures of the light sources.

For example, the first light source 603 may emit light with a relatively cool color temperature, while the second light source 602 emits light with a relatively warm color temperature. By increasing the contribution of one light source relative to the other, the combined illumination pattern can be tuned toward cooler orwarmer appearances. This mixing approach enables smooth transitions between color temperatures without requiring additional optical components.

In some implementations, the driver module 604 may dynamically adjust color temperature based on time of day, ambient light conditions, or user preferences. For instance, cooler light may be used during early evening hours for visibility, while warmer light may be used later at night to create a more relaxing environment.

The color temperature mixing may also be coordinated with spatial beam mixing. The central region and peripheral region may contribute different spectral components that blend in overlapping regions, producing a gradual color transition across the illumination pattern. This effect can enhance visual comfort and aesthetic appeal.

Variations of this approach may include closed-loop control using optical or temperature sensors to maintain consistent color output overtime. The driver module 604 may compensate for aging of LED modules or temperature-induced color shifts to preserve the intended combined illumination pattern.

In further embodiments, the lighting apparatus additionally includes a third light source 709, as illustrated in FIG. 5. The third light source 709 is disposed physically between the first light source 603 and the second light source 602 along a radial or axial direction within the housing 601. This intermediate placement allows the third light source 709 to occupy a transition region between the optical paths of the first and second light sources.

The third light source 709 is configured to emit a third light beam that bridges a transition gap between the first light beam and the second light beam. In particular, the third light beam may have a spread angle intermediate between the first spread angle and the second spread angle. By filling angular regions that are not optimally covered by either the first or second light beams alone, the third light source 709 contributes to a more continuous illumination pattern.

In some embodiments, the third light source 709 operates at a lower intensity than the first light source 603 but higher than portions of the second light source 602. This intensity relationship enables the third light beam to smooth the luminance gradient between the central bright zone and the peripheral illumination zone. As a result, visible rings or abrupt changes in brightness are reduced or eliminated.

The third light source 709 may be driven independently by the driver module 604 or may be driven in coordination with the first and second light sources. In one example, the driver module 604 increases the output of the third light source when the intensity difference between the first and second light sources exceeds a predetermined threshold. This adaptive control further enhances uniformity under varying operating conditions.

Variations of this configuration may include multiple third light sources arranged circumferentially between the first and second light sources, or a continuous ring-shaped third light source. The third light source 709 may also emit light with a distinct color temperature or spectral profile to assist with both spatial and spectral blending in the combined illumination pattern.

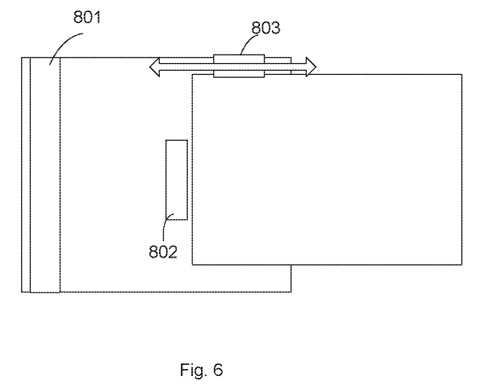

In additional embodiments, the lighting apparatus further comprises a movable mechanism 803, as shown in FIG. 6. The movable mechanism 803 is coupled to the first light source 603 or the second light source 602, and is configured to enable a relative displacement between the light sources 802 and the housing 801. This relative displacement alters the optical relationship between the light sources and associated optical elements.

In some implementations, the movable mechanism 803 allows axial movement of a light source toward or away from an optical element. Such movement modifies the effective focal point and thereby changes the first spread angle or the second spread angle. By adjusting the position of the light source relative to the optical element, the lighting apparatus can adapt its beam profile to different installation heights or target distances.

In other implementations, the movable mechanism 803 permits rotational or angular adjustment of a light source. This enables directional tuning of the emitted beam without repositioning the entire housing 801. Such functionality is particularly useful for garden environments where terrain or vegetation may require customized illumination angles.

The movable mechanism 803 may include mechanical components such as sliding rails, threaded adjustment members, cams, or pivot joints. These components may be manually adjustable during installation or automatically actuated using a motor or actuator controlled by the driver module 604. Locking features may be included to maintain a selected position during operation.

Alternative embodiments may combine limited mechanical movement with electronic beam control to achieve fine adjustment of the illumination pattern. By providing controlled relative displacement, the lighting apparatus can offer adaptable optical performance while maintaining a compact and integrated structure.

In further embodiments, the driver module 604 is configured to adjust an output ratio between the first light source 603 and the second light source 602. The output ratio defines the relative contribution of each light source to the combined illumination pattern. By controlling this ratio, the lighting apparatus can dynamically shift between different lighting effects.

In a first operating mode, the driver module 604 increases the output of the first light source 603 relative to the second light source 602. In this mode, the combined illumination pattern is dominated by the first light beam, resulting in a pronounced spotlight effect suitable for accent lighting or focal illumination.

In a second operating mode, the driver module 604 increases the output of the second light source 602 relative to the first light source 603. This mode produces a wide- area illumination effect in which peripheral lighting dominates, making it suitable for general area lighting or pathway illumination.

The transition between operating modes may be gradual or discrete, depending on control logic implemented in the driver module 604. The driver module 604 may apply predefined ratios or continuously variable ratios to smoothly adjust the balance between the two light sources without abrupt visual changes.

Variations of this approach may include additional intermediate modes, user- defined ratios, or automated mode selection based on environmental inputs. By adjusting the output ratio between the first and second light sources, the lighting apparatus provides flexible illumination behavior while retaining the same physical structure.

In further embodiments, the driver module 604 is configured to apply a compensation formula when adjusting the output ratio between the first light source 603 and the second light source 602. When the driver module 604 increases an intensity of the first light source 603, the driver module automatically decreases an intensity of the second light source 602 according to the compensation formula. This coordinated adjustment maintains a substantially constant total power output or luminous flux of the lighting apparatus.

The compensation formula may be implemented as a linear or non-linear relationship between the output intensities of the first and second light sources. In one example, the sum of electrical power supplied to the first and second light sources is maintained at a fixed value to reduce thermal stress and to extend component lifetime. In another example, the compensation formula is designed to achieve a specific visual transition effect between spotlight-dominant and floodlight-dominant modes.

In some embodiments, the compensation formula takes into account optical efficiency differences between the first light source 603 and the second light source 602. Because the two light sources may use different optical elements and beam shapes, equal electrical power may not result in equal perceived brightness. The compensation formula may therefore incorporate correction factors derived from optical measurements or simulations.

The compensation formula may also be adaptive. For example, the driver module 604 may modify the compensation relationship based on temperature, aging of LED modules, or battery capacity. Such adaptive behavior ensures consistent illumination performance over time and under varying operating conditions.

Variations of the compensation approach may include multiple compensation profiles stored in memory and selected based on operating mode or user preference. This flexibility allows the lighting apparatus to balance efficiency, visual comfort, and functional illumination requirements.

In additional embodiments, the driver module 604 comprises a memory unit 607, as shown in FIG. 4. The memory unit 607 stores a look-up table that defines a non-linear mapping relationship between a user control input and corresponding output intensities of the first light source 603 and the second light source 602. This look-up table enables complex control behavior without requiring real-time computation of output ratios.

The user control input may be provided by a manual switch, a touch interface, or a remote control signal. Each input state or value corresponds to a predefined entry in the look-up table, which specifies target intensities for the first and second light sources. By using a non-linear mapping, the lighting apparatus can provide perceptually uniform transitions or emphasize certain lighting modes.

In some implementations, the look-up table is programmed during manufacturing based on optical testing and desired illumination characteristics. In other implementations, the look-up table may be reprogrammable to allow customization or firmware updates. This enables the lighting apparatus to be tailored to different markets or applications.

The look-up table may also incorporate compensation for human visual perception, such as logarithmic brightness response. By accounting for perceptual factors, small user input changes can result in smooth and intuitive changes in the combined illumination pattern.

Alternative embodiments may include multiple look-up tables selectable based on operating context, such as indoor versus outdoor use or decorative versus functional lighting. The memory-based approach simplifies control logic while enabling sophisticated light output behavior.

In further embodiments, the lighting apparatus includes a manual switch 606 or a touch sensor disposed on the housing 601. The manual switch 606 or touch sensor provides a user-accessible interface for controlling the lighting apparatus. The interface may be positioned on an exterior surface of the housing 601 for convenient operation.

An actuation of the manual switch 606 or the touch sensor triggers the driver module 604 to cycle through a set of predefined spread angle configurations. Each configuration corresponds to a specific combination of output intensities or activation states of the first light source 603 and the second light source 602. As a result, the effective beam shape changes with each actuation.

In one example, successive actuations cycle through a narrow spotlight mode, a blended spotlight-and-flood mode, and a wide floodlight mode. These modes may be stored in the memory unit 607 and recalled sequentially by the driver module 604. This allows users to easily select a desired illumination pattern without complex controls.

The touch sensor may detect capacitive, resistive, or optical input, and may support additional gestures such as long presses or multiple taps to access extended functions. Such gestures may be mapped to specific lighting configurations or operational modes.

Variations of the control interface may include multiple switches, combined mechanical and touch inputs, or integration with remote or wireless control systems. Regardless of the interface type, cycling through predefined spread angle configurations provides a simple and intuitive method for users to adjust illumination behavior.

In further embodiments, the lighting apparatus additionally includes a power management unit 608, a rechargeable battery 609, and a solar panel interface 610, as illustrated in FIG. 4. The solar panel interface 610 is adapted to connect to a photovoltaic module that converts solar energy into electrical energy. The generated electrical energy is supplied to the power management unit 608 to charge the rechargeable battery 609 and to power the lighting apparatus.

The power management unit 608 is electrically coupled to the rechargeable battery 609 and the driver module 604. The power management unit 608 may include charging circuitry, voltage regulation circuitry, and protection features such as overcharge, over- discharge, and short-circuit protection. Through these functions, the power management unit 608 ensures safe and reliable operation of the lighting apparatus under varying environmental and load conditions.

In some embodiments, the rechargeable battery 609 may be a lithium-ion battery, lithium iron phosphate battery, nickel-metal hydride battery, or another suitable rechargeable energy storage device. The battery capacity may be selected based on desired operating duration, illumination intensity, and available solar charging capacity. The rechargeable battery 609 enables autonomous operation of the lighting apparatus without reliance on external power sources.

The solar panel interface 610 may support direct electrical connection to an integrated solar panel mounted on the housing 601 or to a remotely located photovoltaic module. In some implementations, the solar panel interface 610 includes connectors, cables, or terminals designed to withstand outdoor environmental exposure. This modular interface allows flexibility in system design and installation.

Variations of this configuration may include additional energy harvesting interfaces or hybrid power sources. For example, the lighting apparatus may be configured to accept both solar power and grid power, or to integrate with external energy storage systems. These variations extend applicability while maintaining the core power management architecture.

In additional embodiments, the driver module 604 is configured to monitor a capacity level of the rechargeable battery 609. Battery monitoring may be performed using voltage sensing, current integration, temperature sensing, or state-of-charge estimation algorithms. The monitored capacity level provides real-time information about available energy.

When the capacity level falls below a predetermined threshold, the driver module 604 automatically restricts a maximum intensity of the first light source 603 or the second light source 602. By limiting output intensity, the lighting apparatus reduces power consumption and extends remaining operating time. This adaptive behavior helps prevent abrupt shutdown during periods of low battery charge.

In some implementations, the driver module 604 prioritizes one light source over the other when operating under reduced power conditions. For example, the driver module 604 may maintain minimum illumination from the second light source 602 for safety while reducing output from the first light source 603. Such prioritization may be configurable based on application requirements.

The restriction of maximum intensity may be gradual rather than abrupt. The driver module 604 may progressively reduce brightness as battery capacity decreases, thereby providing a smooth transition and visual indication of reduced energy availability.

Alternative embodiments may include user notifications or status indicators that reflect battery capacity or reduced-power operation. These features improve usability while preserving energy-efficient operation.

In further embodiments, the driver module 604 includes a timer circuit 611, as shown in FIG. 4. The timer circuit 611 is configured to control operating duration of the lighting apparatus. The timer circuit 611 may deactivate the lighting apparatus or dim the first light source 603 and the second light source 602 after a predetermined duration.

In one example, the timer circuit 611 turns off the lighting apparatus after a fixed number of hours following activation. This function conserves energy and prevents unnecessary illumination during periods of low activity. The predetermined duration may be selected based on typical usage patterns or regulatory requirements.

In other embodiments, the timer circuit 611 operates based on a specific time of day. For example, the timer circuit 611 may deactivate or dim the lighting apparatus during late-night hours when illumination demand is reduced. Time-based control may be synchronized using an internal clock or external timing signals.

The timer circuit 611 may cooperate with the power management unit 608 and the battery monitoring functions of the driver module 604. For instance, the timer duration may be adjusted dynamically based on battery capacity or recent charging history to optimize energy usage.

Variations of the timer functionality may include multiple programmable schedules, user-adjustable timing parameters, or integration with ambient light sensors. These variations allow the lighting apparatus to provide intelligent, energy-efficient operation while maintaining user convenience.

In further embodiments, the lighting apparatus includes a wireless communication module 605, as illustrated in FIG. 4. The wireless communication module 605 is configured to receive a wireless broadcast signal from an external transmitter, such as a remote controller, a gateway device, or another lighting apparatus. The wireless communication module 605 may operate using radio frequency, Bluetooth, Wi-Fi, sub-GHz communication, or other short-range or long-range wireless protocols suitable for outdoor environments.

Upon receipt of the wireless broadcast signal, the driver module 604 activates a specific lighting scene or synchronization mode. The lighting scene may define predefined output intensities, color temperatures, color patterns, or spread angle configurations for the first light source 603 and the second light source 602. This allows multiple lighting apparatuses installed in a common area to respond simultaneously to a single wireless command.

In some embodiments, the synchronization mode enables coordinated behavior among multiple lighting units. For example, several lighting apparatuses may gradually change brightness or color in unison, or switch between spotlight-dominant and floodlight- dominant modes simultaneously. Such synchronization enhances visual consistency in landscape or pathway lighting installations.

The wireless communication module 605 may also support bidirectional communication, allowing the lighting apparatus to transmit status information such as battery level, operating mode, or fault conditions. This information may be received by a central controller or monitoring system to facilitate maintenance and system management.

Variations of the wireless functionality may include encrypted communication, device addressing, or group control features. These variations enable secure, scalable, and flexible wireless control of multiple lighting apparatuses without modifying the underlying optical or electrical architecture.

In additional embodiments, the lighting apparatus further includes a mounting stake 605 coupled to the housing 601, as shown in FIG. 4. The mounting stake 605 is configured to anchor the lighting apparatus into a ground surface such as soil, gravel, or grass. This configuration is particularly suitable for garden, landscape, or pathway lighting applications.

The mounting stake 605 may be formed as a rigid elongated structure that extends downward from the housing 601. The stake may include a pointed or tapered end to facilitate insertion into the ground. In some implementations, the mounting stake 605 is removably attached to the housing 601 to allow alternative mounting options, such as wall mounting or surface mounting.

In certain embodiments, the mounting stake 605 allows limited angular adjustment of the housing 601 relative to the ground. This adjustment enables the output direction of illumination to be aimed toward a desired target area without repositioning the entire fixture. Locking features may be provided to maintain the selected orientation.

The mounting stake 605 may be constructed from metal, reinforced plastic, or composite materials selected for strength and corrosion resistance. Surface coatings or treatments may be applied to improve durability in outdoor environments.

Alternative embodiments may include interchangeable mounting accessories, such as brackets or clamps, that use the same housing 601. This modular mounting approach allows the lighting apparatus to be adapted for different installation scenarios while maintaining consistent optical and electrical performance.

In further embodiments, the housing 601 comprises a heat sink structure 613 constructed from a thermally conductive material, as illustrated in FIG. 4. The heat sink structure 613 is thermally coupled to the first light source 603 and the second light source 602 to dissipate heat generated during operation.

The heat sink structure 613 may include fins, ribs, or extended surfaces that increase surface area and promote convective heat transfer to the surrounding environment. By efficiently dissipating heat, the heat sink structure 613 helps maintain the junction temperature of the light sources within acceptable limits, thereby improving efficiency and extending operational lifetime.

In some embodiments, the heat sink structure 613 is integrally formed with the housing 601. For example, the housing 601 may be made of aluminum or another thermally conductive metal that simultaneously provides structural support and thermal management. This integration reduces part count and improves thermal performance.

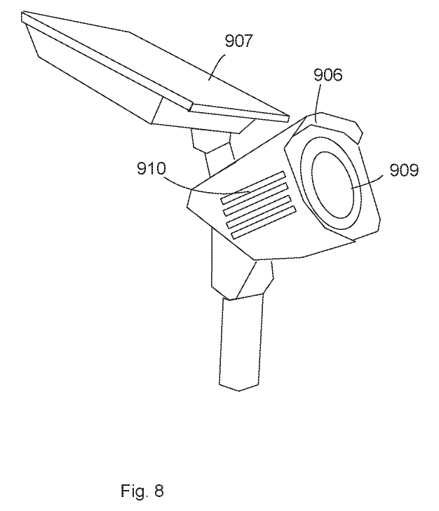

FIG. 8 shows another lighting apparatus embodiment. The lighting apparatus includes a light source part 909 that contains two light sources disposed in a housing 906. There are heat sink structure 910 disposed on the housing 906 to carry out heat of the light sources. There is a solar panel 907 to convert light energy at day time to save energy in a battery so that the lighting apparatus may function in night time.

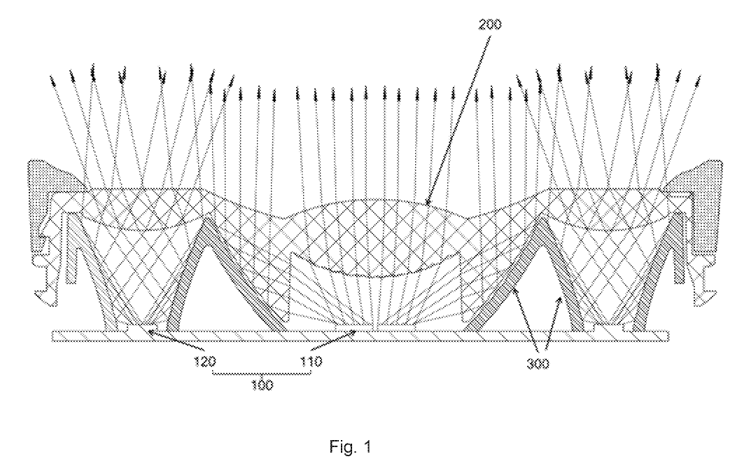

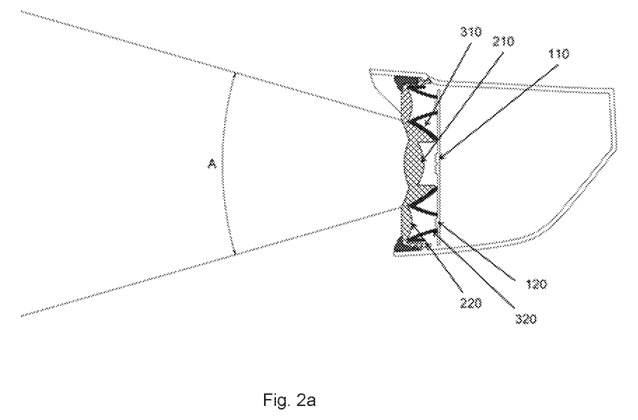

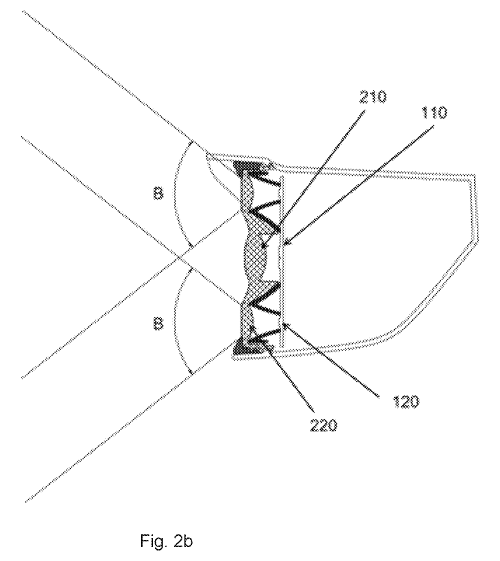

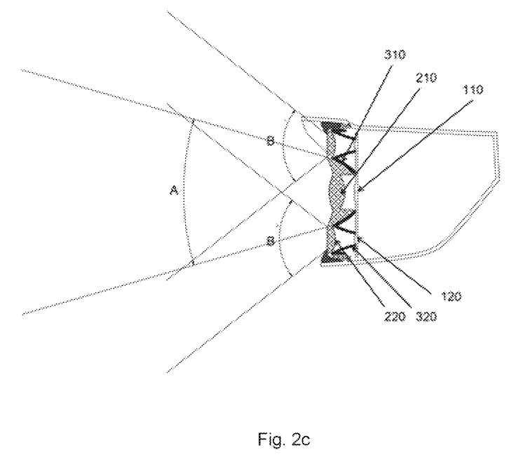

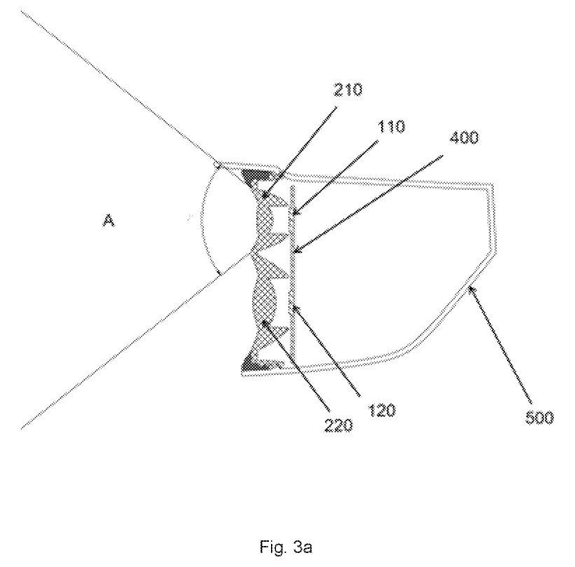

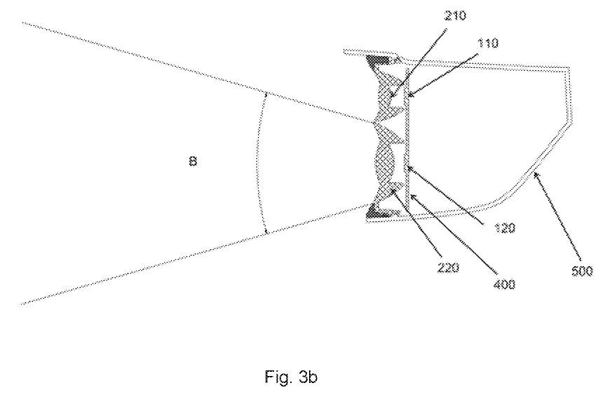

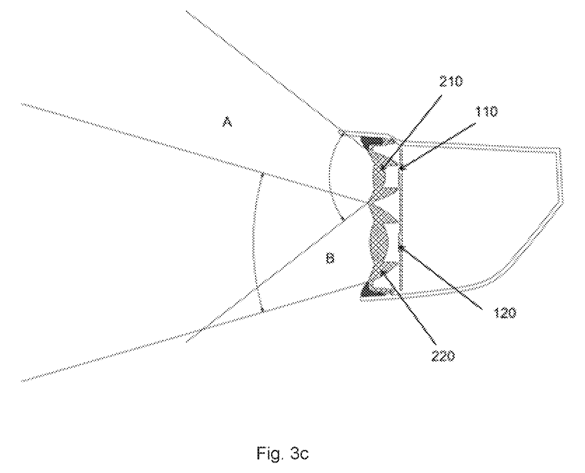

FIG. 1 is a schematic structural diagram of a mixed-light luminaire provided by some embodiment of the present application; FIG. 2a-FIG. 2c are schematic structural diagrams of another exemplary mixed-light luminaire provided by some embodiment of the present application; and FIG. 3a-FIG. 3c are schematic structural diagrams of yet another exemplary mixed-light luminaire provided by some embodiment of the present application.

The present application proposes a mixed-light luminaire. As shown in FIG. 1 and FIG. 2, the mixed-light luminaire includes a light source 100, a lens 200, a reflector cup 300, a control module 400, and a housing 500. The lens 200 is disposed on a light-emitting surface of the light source 100, and the reflector cup 300 is disposed around a peripheral region of the light-emitting surface of the light source. The control module 400 is electrically connected to the light source 100 and is used to control optical parameters of the light source 100. The housing 500 defines an accommodating space for accommodating the light source 100, the lens 200, the reflector cup 300, and the control module 400.

In some embodiments of the present application, the light source 100 may be a white light LED, an RGB LED, or a mixed unit composed of a white light LED and an RGB LED.

For better explanation of some embodiments of the present application, in the following embodiments the light source 100 is illustrated using RGB LEDs as an example, and a first light source 110 and a second light source 120 emit monochromatic light of different colors.

In one embodiment of the present application, the light source 100 includes a first light source 110 and a second light source 120, the lens 200 includes a first lens 210 and a second lens 220, and the reflector cup 300 includes a first reflector cup 310 and a second reflector cup 320. The first lens 210 is disposed on a light-emitting surface of the first light source 110, and the first reflector cup 310 is disposed around a peripheral region of the light-emitting surface of the first light source 110. The second lens 220 is disposed on a light-emitting surface of the second light source 120, and the second reflector cup 320 is disposed around a peripheral region of the light-emitting surface of the second light source 120.

When the first light source 110 is turned on, light cooperatively interacts with the first reflector cup 310 and the first lens 210, and forms a first angular light distribution emitted from a light-emitting surface of the first lens 210, where a beam angle of the first light distribution is a first beam angle A. When the second light source 120 is turned on, light cooperatively interacts with the second reflector cup 320 and the second lens 220, and forms a second angular light distribution emitted from a light-emitting surface of the second lens 220, where a beam angle of the second light distribution is a second beam angle B.

In one embodiment of the present application, the second light source 120 is configured as a substantially annular LED array, and the second light source 120 is disposed around a peripheral region of the first light source 110. FIG. 2a is a schematic diagram illustrating the first beam angle A of the mixed-light luminaire according to one embodiment of the present application, FIG. 2b is a schematic diagram illustrating the second beam angle B of the mixed-light luminaire according to one embodiment of the present application, and FIG. 2c is a schematic diagram illustrating overlap between the first beam angle A and the second beam angle B according to one embodiment of the present application.

As shown in FIG. 2a, FIG. 2b, and FIG. 2c, the first beam angle A and the second beam angle B of the mixed-light luminaire may overlap with each other. Through overlap between the first beam angle A and the second beam angle B, light emitted from the first light source and light emitted from the second light source, having different optical parameters, are mixed. This overlap improves mixed-light uniformity and brightness in the overlapping region, thereby enhancing user experience.

In some embodiments of the present application, a range of the first beam angle A is from 20 degrees to 110 degrees, and a range of the second beam angle B is from 20 degrees to 110 degrees.

In some other embodiments of the present application, the range of the first beam angle A is from 20 degrees to 90 degrees, and the range of the second beam angle B is from 30 degrees to 110 degrees.

When the first beam angle A is smaller than the second beam angle B, that is, when the angular range of the first beam angle A is from 30 degrees to 110 degrees and the angular range of the second beam angle B is from 60 degrees to 100 degrees, light within an overlapping portion of the first beam angle A and the second beam angle B is mixed to achieve a mixed-light effect. This improves mixed-light uniformity and brightness in the overlapping region. In addition, edges of the overlapping portion between the first beam angle and the second beam angle may present a natural gradient transition effect.

When the first beam angle A is equal to the second beam angle B, light within the overlapping portion of the first beam angle A and the second beam angle B is mixed to achieve a mixed-light effect, thereby improving mixed-light uniformity and brightness in the overlapping region.

In another embodiment of the present application, when the first beam angle A is greater than the second beam angle B, light within the overlapping portion of the first beam angle A and the second beam angle B is mixed to achieve a mixed-light effect, thereby improving mixed-light uniformity and brightness in the overlapping region. In addition, edges of the overlapping portion between the first beam angle and the second beam angle may present a natural gradient transition effect.

In one embodiment of the present application, the second light source 120 is disposed on one side of the first light source 110. FIG. 3a is a schematic diagram illustrating the first beam angle of the mixed-light luminaire according to one embodiment of the present application, FIG. 3b is a schematic diagram illustrating the second beam angle of the mixed-light luminaire according to one embodiment of the present application, and FIG. 3c is a schematic diagram illustrating overlap between the first beam angle and the second beam angle according to one embodiment of the present application.

As shown in FIG. 3a, FIG. 3b, and FIG. 3c, the first beam angle and the second beam angle of the mixed-light luminaire may overlap with each other. Through overlap between the first beam angle and the second beam angle, light emitted from the first light source and light emitted from the second light source, having different optical parameters, is mixed. This improves uniform mixed-light performance in the overlapping region and enhances user experience.

As shown in FIG. 3c, when the first beam angle A is smaller than the second beam angle B, light within the overlapping portion of the first beam angle A and the second beam angle B is mixed to achieve a mixed-light effect, thereby improving mixed-light uniformity and brightness in the overlapping region. In addition, edges of the overlapping portion between the first beam angle and the second beam angle may present a natural gradient transition effect.

When the first beam angle A is equal to the second beam angle B, light within the overlapping portion of the first beam angle A and the second beam angle B is mixed to achieve a mixed-light effect, thereby improving mixed-light uniformity and brightness in the overlapping region.

In another embodiment of the present application, a second light source 120 is disposed on both upper and lower sides or both left and right sides of the first light source 110, so as to achieve a mixed-light effect similar to that illustrated in FIG. 3c.

Through cooperative design of the light sources, lenses, and reflector cups, some embodiments of the present application utilize overlap among multiple beam angles to achieve a mixed-light effect with high uniformity and high brightness. Moreover, when beam angles differ in size, edges between overlapping portions and non-overlapping portions can present a natural gradient transition effect. Such a mixed-light luminaire is suitable not only for professional lighting applications but also for entertainment lighting applications, thereby improving overall user experience.

In some embodiments, relative spatial positioning between the first light source and the second light source may be adjusted not only radially but also axially, such that a distance between at least one light source and a corresponding optical element is modified. Such axial displacement may alter effective beam divergence, focal characteristics, or beam uniformity, thereby providing an additional degree of freedom in shaping the combined illumination pattern.

In certain embodiments, the first optical element and the second optical element may be integrally formed as a single optical component with multiple functional regions. For example, a central region of the optical component may provide collimation suitable for spotlight illumination, while a peripheral region may provide diffusion or wide-angle distribution suitable for floodlight illumination, thereby reducing part count and simplifying assembly.

In some embodiments, the reflector cup may include regions having different reflectivity characteristics. For instance, a first region may be highly specular to preserve beam efficiency, while a second region may be semi-diffuse to enhance light mixing. Such mixed-surface designs allow fine tuning of edge softness, glare reduction, and spatial blending between light beams.

In further embodiments, the driver module may incorporate adaptive control logic based on sensed environmental parameters. For example, ambient light sensors, temperature sensors, or motion sensors may provide input signals to the driver module, enabling automatic adjustment of output intensity, beam ratio, or color characteristics in response to environmental conditions.

In some embodiments, beam overlap characteristics may be intentionally asymmetric. For example, the overlap region may be biased toward one side of the output direction to compensate for asymmetric installation environments, such as wall-adjacent mounting or directional pathway illumination. This asymmetric overlap may be achieved through optical shaping, selective activation of LED sets, or reflector geometry design.

In certain embodiments, the lighting apparatus may support firmware updates through wired or wireless interfaces. Such updates may modify control algorithms, compensation formulas, or look-up tables stored in memory, thereby enabling post- deployment optimization, feature enhancement, or regulatory compliance updates without hardware modification.

In some embodiments, thermal management may be dynamically coordinated with optical output. For example, when elevated temperature is detected near one light source, the driver module may temporarily reduce its output while increasing output from another light source to maintain overall illumination performance while protecting components from thermal stress.

In further embodiments, the lighting apparatus may support grouping or zoning functionality when multiple units are deployed. Units within a defined group may coordinate beam patterns, color temperatures, or timing behavior to produce spatial lighting effects across a landscape, architectural facade, or entertainment venue.

In some embodiments, optical components may be fabricated using different materials or manufacturing processes. For example, lenses may be injection-molded plastic, silicone, or glass, and micro-structured features may be formed using precision molding, laser etching, or surface replication techniques, allowing trade-offs between cost, durability, and optical performance.

In certain embodiments, the mixed-light luminaire architecture may be applied to lighting devices beyond garden or pathway fixtures. For example, the same principles may be adapted for stage lighting, architectural wall washers, automotive auxiliary lighting, or portable lighting devices, demonstrating that the disclosed structure and control methods are broadly applicable across multiple lighting domains.

The thermal coupling between the heat sink structure 613 and the light sources may be achieved using thermal interface materials, such as thermal grease, pads, or adhesive layers. These materials reduce thermal resistance and improve heat transfer from the light sources to the heat sink structure.

Variations of the thermal management design may include passive airflow channels, heat pipes, or phase-change materials. These variations allow the lighting apparatus to accommodate higher power operation or more compact designs while maintaining reliable thermal performance.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a housing, wherein the housing is configured to enclose internal components,
wherein the housing defines an output direction for illumination;a first light source, wherein the first light source is disposed within the housing,
wherein the first light source is configured to emit a first light beam having a first spread angle;a second light source, wherein the second light source is disposed within the housing at a position located at least partially along a peripheral side of the first light
source, wherein the second light source is configured to emit a second light beam having a second spread angle; and a driver module, wherein the driver module is electrically coupled to the first light source and the second light source to regulate an output intensity of the first light beam and the second light beam, wherein the first light beam and the second light beam are
projected to form a combined illumination pattern, wherein the first spread angle and the second spread angle at least partially overlap.

2. The lighting apparatus of claim 1, further comprising a first optical element and a second optical element, wherein the first optical element is disposed adjacent to the first
light source and comprises a total internal reflection (TIR) lens structure to collimate the first light beam, wherein the second optical element is disposed adjacent to the second light source and operates in conjunction with a reflector cup to direct the second light beam.

3. The lighting apparatus of claim 2, wherein the first spread angle is configured to be in a range of 20 degrees to 110 degrees to provide a spotlight effect, wherein the second
spread angle is configured to be in a range of 20 degrees to 110 degrees to provide a floodlight effect, wherein the second spread angle is wider than the first spread angle to form the combined illumination pattern with a central bright zone and a peripheral gradient zone.

4. The lighting apparatus of claim 3, wherein the first optical element or the second optical element comprises an exit surface having a micro-lens array, wherein the micro- lens array is arranged in a Fermat spiral distribution or a non-aspherical coordinate distribution defined by a specific curvature formula to enhance light mixing uniformity.

5. The lighting apparatus of claim 2, wherein the reflector cup surrounds the first light source and separates the first light source from the second light source, wherein the reflector cup comprises a faceted or scaled reflective surface configured to reflect stray light from the first light source or the second light source back into the first optical element
or the second optical element.

6. The lighting apparatus of claim 1, wherein the first light source and the second light source each comprise at least one light emitting diode (LED) module, wherein the LED module is configured to emit light of a selectable color temperature or a selectable RGB
color, wherein the driver module is configured to independently adjust a color output of the first light source and the second light source.

7. The lighting apparatus of claim 6, wherein the first light source or the second light source comprises a plurality of independently addressable LED sets, wherein the driver
module is configured to selectively activate a subset of the plurality of independently
addressable LED sets to discretely modify the first spread angle or the second spread angle without moving mechanical parts.

8. The lighting apparatus of claim 6, wherein the driver module is configured to
adjust a color temperature of the combined illumination pattern by mixing a first color temperature output from the first light source and a second color temperature output from the second light source.

9. The lighting apparatus of claim 1, further comprising a third light source, wherein
the third light source is disposed physically between the first light source and the second light source, wherein the third light source is configured to emit a third light beam to bridge a transition gap between the first light beam and the second light beam to create a continuous light pattern.

10. The lighting apparatus of claim 1, further comprising a movable mechanism,
wherein the movable mechanism is coupled to the first light source or the second light source to enable a relative displacement between the light sources and the housing,
wherein the relative displacement modifies the first spread angle or the second spread angle to adapt to different garden environments.

11. The lighting apparatus of claim 1, wherein the driver module is configured to adjust an output ratio between the first light source and the second light source, wherein the driver module operates in a first mode where the first light source dominates for a spotlight effect, and a second mode where the second light source dominates for a wide-
area illumination effect.

12. The lighting apparatus of claim 11, wherein the driver module is configured to apply a compensation formula, wherein when the driver module increases an intensity of the first light source, the driver module automatically decreases an intensity of the second light source according to the compensation formula to maintain a total power output or to
achieve a specific beam transition effect.

13. The lighting apparatus of claim 11, wherein the driver module comprises a memory unit storing a look-up table, wherein the look-up table defines a non-linear mapping relationship between a user control input and corresponding output intensities of
the first light source and the second light source.

14. The lighting apparatus of claim 1, further comprising a manual switch or a touch sensor, wherein the manual switch or the touch sensor is disposed on the housing, wherein an actuation of the manual switch or the touch sensor triggers the driver module to cycle
through a set of pre-defined spread angle configurations.

15. The lighting apparatus of claim 1, further comprising a power management unit,
a rechargeable battery, and a solar panel interface, wherein the solar panel interface is adapted to connect to a photovoltaic module to charge the rechargeable battery, wherein
the power management unit powers the driver module.

16. The lighting apparatus of claim 15, wherein the driver module is configured to monitor a capacity level of the rechargeable battery, wherein the driver module automatically restricts a maximum intensity of the first light source or the second light
source when the capacity level falls below a predetermined threshold.

17. The lighting apparatus of claim 15, wherein the driver module further comprises a timer circuit, wherein the timer circuit is configured to deactivate the lighting apparatus or dim the first light source and the second light source after a predetermined duration or at a specific time of day to conserve energy.

18. The lighting apparatus of claim 1, further comprising a wireless communication module, wherein the wireless communication module is configured to receive a wireless broadcast signal, wherein the driver module activates a specific lighting scene or synchronization mode upon receipt of the wireless broadcast signal.

19. The lighting apparatus of claim 1, further comprising a mounting stake, wherein the mounting stake is coupled to the housing, wherein the mounting stake is configured to anchor the lighting apparatus into a ground surface for garden or pathway illumination.

20. The lighting apparatus of claim 1, wherein the housing comprises a heat sink structure constructed from a thermally conductive material, wherein the heat sink structure is thermally coupled to the first light source and the second light source to dissipate heat generated during operation to an external environment.
